(19) United States
(12) Patent Application Publication
(10) Pub. No.: US 2009/0265440 A1
(43) Pub. Date: Oct. 22, 2009

(54) SYSTEM AND METHOD FOR BILLING ONLY FOR E-MAILS ACTUALLY DELIVERED TO RECIPIENTS' INBOXES

(76) Inventors: Matt Blumberg, Scarsdale, NY (US); George Bilbrey, Lafayette, CO (US); John Sinclair, Port Washington, NY (US)

Correspondence Address: Blank Rome LLP, 600 New Hampshire Ave., NW, Washington, DC, 20037, US

(21) Appl. No.: 12/372,736

(22) Filed: Feb. 17, 2009

Related U.S. Application Data
(63) Continuation of application No. 12/167,015, filed on Jul. 2, 2008, now abandoned.
(60) Provisional application No. 60/929,547, filed on Jul. 2, 2007.

(51) Int. Cl. G06F 15/16; G06Q 30/00; G06Q 50/00; G06F 17/30

(52) U.S. Cl. 709/206; 705/34; 707/104.1

(57) ABSTRACT

A method for conducting an e-mail campaign is provided. The method includes the steps of: (a) sending e-mails to a plurality of intended recipients; (b) determining a number of the e-mails that have been indicated as nondeliverable; (c) determining a number of the e-mails that have been identified as bulk and not delivered to the intended recipients; (d) determining, from the determinations made in steps (b) and (c), a number of the e-mails that have reached the intended recipients; and (e) billing only for the number of e-mails determined in step (d).

### CROSS REFERENCE TO RELATED APPLICATION

This application claims the benefit of U.S. Provisional Patent Application No. 60/929,547 filed Jul. 2, 2007 in the U.S. Patent and Trademark Office, titled “SYSTEM AND METHOD FOR BILLING ONLY FOR E-MAILS ACTUALLY DELIVERED TO RECIPIENTS' INBOXES,” the entire disclosure of which is incorporated herein by reference.

### FIELD OF THE INVENTION

The present invention is directed to a system and method for billing for e-mail campaigns and more specifically to such a system and method in which the client is billed only for those e-mails that are actually delivered to recipients' inboxes.

### BACKGROUND OF THE INVENTION

E-mail campaigns involve sending e-mail to a large number of intended recipients. Throughout the present disclosure, 100,000 intended recipients will be used as an illustrative rather than limiting example.

Traditionally, the client of such a service has been billed for all 100,000 intended recipients. However, not all of those 100,000 intended recipients will actually receive the e-mails. For example, the e-mail addresses for some of those recipients may no longer be valid or may never have been valid. Also, an e-mail spam filter may prevent some of the e-mails from reaching their intended recipients. As an example, out of the 100,000 e-mails sent to intended recipients, 10,000 may be sent to invalid e-mail addresses, and another 10,000 may be trapped in spam filters, in which case only 80,000 are delivered.

In such a case, the client may well object to paying for all 100,000 e-mails. It is known in the art to deduct those e-mails for which nondelivery notifications have been received (i.e., those that have been “bounced”). However, there is still the matter of the 10,000 that have been trapped in spam filters, as the sender is typically not notified that they have been.

### SUMMARY OF THE INVENTION

It is therefore an object of the invention to take into account all non-delivered e-mails.

To achieve the above and other objects, the present invention is directed to a technique for conducting an e-mail campaign in which both bounced e-mails and those trapped in spam filters are taken into account. In the above example, the client will be billed only for the 80,000 e-mails actually delivered.

According to one aspect of the invention, a method for conducting an e-mail campaign includes the steps of: (a) sending e-mails to a plurality of intended recipients; (b) determining a number of the e-mails that have been indicated as nondeliverable; (c) determining a number of the e-mails that have been identified as bulk and not delivered to the intended recipients; (d) determining, from the determinations made in steps (b) and (c), a number of the e-mails that have reached the intended recipients; and (e) billing only for the number of e-mails determined in step (d).

### BRIEF DESCRIPTION OF THE DRAWINGS

A preferred embodiment of the invention will be set forth in detail with reference to the drawings, in which:

FIG. 1 is a flow chart showing the operation of the preferred embodiment; and

FIG. 2 is a block diagram of hardware on which the preferred embodiment can be implemented.

### DETAILED DESCRIPTION OF THE PREFERRED EMBODIMENT

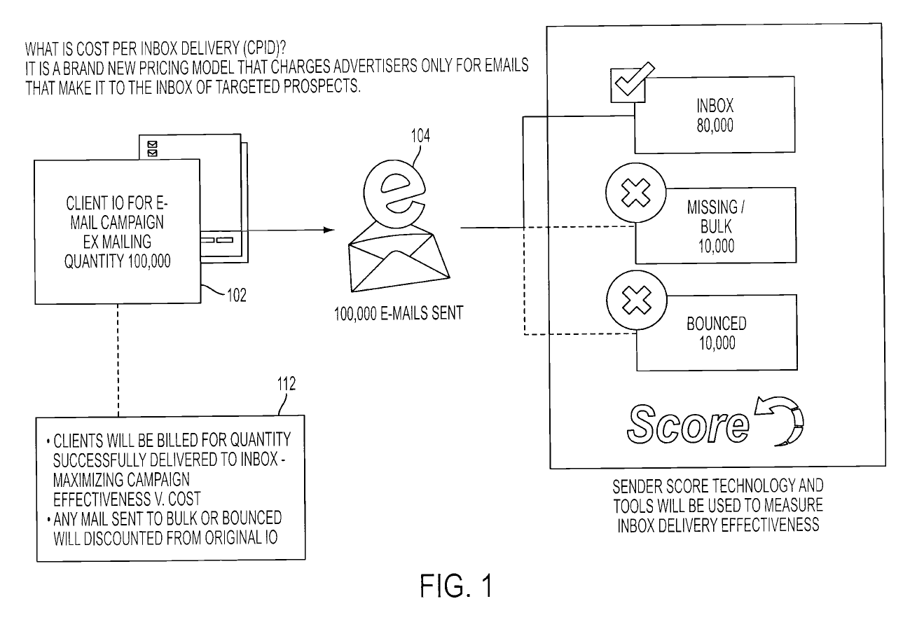

As shown in FIG. 1, an e-mail campaign 102 involves the sending of 100,000 e-mail messages 104. Of those 100,000 e-mail messages, 80,000 reach the intended recipients' inboxes 106, while 10,000 are determined to be missing or bulk (i.e., trapped in spam filters) 108, and another 10,000 are known to be bounced 110 because the nondelivery notices have been received. In step 112, all e-mails 108 and 110 are deducted from the client's bill, so that the client is billed only for those that are determined actually to have reached the intended recipients' inboxes 106.

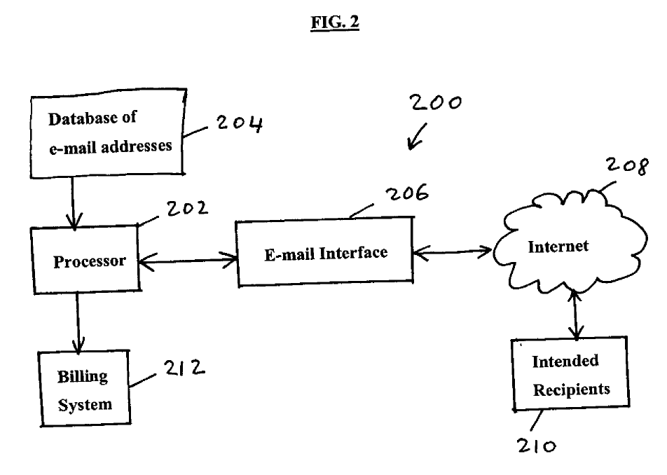

As shown in FIG. 2, a system 200 for implementing the above method includes a processor 202, which can be any suitable processor running any suitable operating system. The processor is in communication with a database 204 of e-mail addresses for the e-mail campaign. The processor 202 prepares the campaign and sends the e-mails through an e-mail interface 206 over the Internet 208 or another suitable communication medium to intended recipients 210. The processor 202 also determines which e-mails have been bounced and how many are estimated to have been trapped in spam filters. A billing system 212 in communication with the processor 202 prepares a bill for the client in accordance with the above.

An example of a method used to perform step 108 will now be disclosed. It will be understood that any other suitable method can be used within the scope of the invention.

That method uses what is called a “seed list,” namely, a list of e-mail addresses that are added to the list of e-mail addresses for intended recipients in the campaign. The seed addresses are distributed throughout the mailing list or individual campaign segments for which deliverability is to be monitored. The seed addresses should preferably be distributed across the list or segment, e.g., by inserting them and then alphabetizing the list. Placement of the seed list at the beginning or end of a segment may skew or nullify chances of obtaining any meaningful deliverability results.

Techniques are known in the art to estimate the percentage of e-mails in a given campaign that are trapped in spam filters. While exact numbers are unavailable, it is possible to use statistical techniques to provide a good estimate. One such technique is Sender Score, a service of Return Path, Inc. Others are known in the art; therefore, the present invention should not be construed as limited by any one such technique.

While a preferred embodiment has been set forth above, those skilled in the art who have reviewed the present disclosure will readily appreciate that other embodiments can be realized within the scope of the invention. For example, numerical values are illustrative rather than limiting, as are disclosures of specific technologies, including specific technologies for estimating the proportion of e-mails that are trapped in spam filters. Therefore, the present invention should be construed as limited only by the appended claims.

What is claimed is:

1. A method for conducting an e-mail campaign, the method comprising:
(a) sending e-mails to a plurality of intended recipients;
(b) determining a number of the e-mails that have been indicated as nondeliverable;
(c) determining a number of the e-mails that have been identified as bulk and not delivered to the intended recipients;
(d) determining, from the determinations made in steps (b) and (c), a number of the e-mails that have reached the intended recipients; and
(e) billing only for the number of e-mails determined in step (d).

2. The method of claim 1, wherein step (d) comprises a step of obtaining a total number of e-mails sent in step (a) from a database containing e-mail addresses of the intended recipients.

3. The method of claim 2, wherein step (d) further comprises a step of subtracting the number of e-mails determined in steps (b) and (c) from the total number of e-mails sent in step (a).

4. The method of claim 3, further comprising the steps of, prior to step (a):
adding a seed list of e-mail addresses to the database of e-mail addresses of the intended recipients;
alphabetizing the e-mail addresses in the database;
monitoring a proportion number of e-mails from the seed list being indicated as bulk and nondelivered, wherein the proportion number is utilized for determining step (c).
